(19) United States
(12) Patent Application Publication
(10) Pub. No.: US 2004/0230462 A1
(43) Pub. Date: Nov. 18, 2004

(54) Method for determining fair market value of product lease equipment in a multi-price structure environment

(75) Inventors: John Wozniak JR., Webster, NY (US); David L. Rowlands, Honeoye Falls, NY (US); Paul J. Benson, Penfield, NY (US)

Correspondence Address: Xerox Corporation, Patent Documentation Center, Xerox Square 20th Floor, 100 Clinton Ave. S., Rochester, NY, 14644, US

(73) Assignee: Xerox Corporation

(21) Appl. No.: 10/436,032

(22) Filed: May 12, 2003

(51) Int. Cl. G06F 17/60

(52) U.S. Cl. 705/7

(57) ABSTRACT

The method first defines a population for Product Cash Revenue and a population for Product Lease Revenue and calculating the mean, median, and variance of the populations and determining therefrom the normality of each of the distributions. Next, the variances of each of the distributions are compared for equivalency by a Homogeneity of Variance test. If each of the distributions are not normal and the variances are not equal then the fair market value is not determinable. Otherwise, if each of the distributions are not normal and the variances are equal then the method further comprises determining if the medians of each of the distributions are equivalent by Mann-Whitney. If the medians of each of the distributions are not equivalent then the values of the leases are adjusted by the lowest constant in whole dollars until the means of each distribution are equivalent. However, if the medians of each of the distributions are equivalent then the cash population is equivalent to the lease population for fair market value purposes. If each of the distributions are normal then the means of each of the distributions need to be compared for equality wherein if the variances are equal then the test for determining if the means are equal is a T-Test for equal variances and if the variances are not equal then the test for determining if the means are equal is a T-Test for unequal variances. If the means are equivalent then the cash population is equivalent to the lease population for fair market value purposes but if the means are not equivalent then the values of the leases need to be adjusted by the lowest constant in whole dollars until the means of each distribution are equivalent.

### FIELD OF THE INVENTION

The present invention generally relates to financial restatement methods and, more particularly, to methods for determining fair market value of equipment leases.

### BACKGROUND OF THE INVENTION

A Lease is a contract through which an owner of equipment, the lessor, conveys the right to use its equipment to another party, the lessee, for a specified period of time and for specified periodic payments. A Lease Schedule is a schedule to a Master Lease agreement describing the leased equipment, rentals and other terms applicable to that equipment. A Lease Term is the fixed, non-cancelable term of the lease. A Lessee is the party to a lease agreement who has been given the right to use the equipment for the lease term by the party who has legal or tax title to the equipment and who is entitled to receive rental payments from the lessee. And the Lessor is the owner of equipment that is being leased to a lessee or user.

As businesses prepare to compete and grow in the 21st century, many are searching for new ways to address their equipment financing challenges. Ways that will give them the tools they need today and the flexibility they need for tomorrow. That's why leasing has become such a huge factor in today's competitive work environment. Equipment Leasing Association (ELA) research shows that eight out of 10 U.S. companies lease some or all of their equipment. And of all the ways to acquire equipment, leasing is the method most frequently used for all equipment types. What's more, almost anything can be leased—from fax machines and printing presses, to trucks and bulldozers.

Anyone from small, one-person operations to Fortune 100 corporations and the equipment you can lease is just as diverse. Transactions range from a few thousand dollars worth of facilities equipment (such as new lighting) to multi-million dollar clean room facilities as there's no end to the type of equipment companies lease so there's no end to the list of who should be leasing.

Many companies and other organizations lease their equipment presently. Equipment can be leased for virtually every industry sector that conducts business, for example, boilers, controls, communication systems, pumps, motors, electrical equipment, energy systems, and generation facilities.

There are many benefits for leasing such equipment. Some of these are the following: Conserve Capital: By leasing your equipment, you can make better use of your working capital to meet the day-to-day needs of your business, like business development, paying suppliers or payroll. Protect Credit Lines: By leasing, there is no impact on existing lines of credit with your bank. Hedge Against Inflation: By leasing, you can acquire use of equipment at today's costs while meeting rental payments with tomorrow's inflated dollars. As price levels continue upward leasing offers a very clear advantage. Pay for Use: By leasing, you have a monthly payment that matches the useful life of the equipment instead of paying a large purchase price up front. Business and industry profit by using equipment, not owning equipment. Budget Restrictions: By leasing, you have minimum cash outlay up front, plus modest payments enable you to fit the lease payment into your budget. Leasing makes it possible to obtain the equipment you need, when you need it. Simplified Transaction: By leasing, you may be qualified for favorable tax deductions. Consult your tax and legal advisors for advice on the potential benefits of leasing. And, lastly because of Obsolescence: By leasing, you can have regular equipment replacement which, in turn, increases production. You have the flexibility to return the equipment, buy it, or renew payments at the end of the lease term. Worn out or insufficient machines are easily replaced.

Providing lease financing helps equipment dealers increase sales by offering lease financing to their clients as part of their sales package. With good credit and positive cash flow, lease underwriters will give you more credit than anyone else because the transactions are asset backed. Most traditional lenders don't like to handle equipment because they're not experts at it. They would rather lend on assets that will appreciate like real estate. The end result is longer turn around, more liens and collateral, and worse terms for you on equipment that is critical to your business.

Leasing typically involves a small monthly payment. When you know what bills are coming it reduces impact on cash flow and makes cash flow forecasting easier. Customers will often decide to acquire more costly equipment and/or more equipment than if they had to purchase with cash. The results in increased income because additional orders and equipment upgrades often lead to more sales. A lease payment can be often approved from customers' operating budget, as there is often no need for head office approval. In addition, available budget dollars will allow the leasing of more equipment over a given period of time which can lead to multiple sales. At the end term, lessees will often go back to the original dealer to upgrade or purchase new equipment and the lessee most likely has already become accustomed to making lease payment.

Fair Market Value (FMV) is the price for which property can be sold in an “arms length” transaction; that is, between informed, unrelated, and willing parties each of which is acting rationally and in his/her own best interest. The Estimated Useful Life of a lease is the period during which an asset is expected to be useful in trade or business. Whereas, the Fair Market Purchase Option is an option given to the lessee to purchase the leased equipment from the lessor at its fair market value at the expiration of the lease term. Whereas a Fixed Purchase Option is an option given to the lessee to purchase the leased equipment form the lessor on the option date for a guaranteed price. Both the date and the price must be determined at the inception of the lease. A typical fixed purchase option is 10% of the original cost of the equipment.

An Operating Lease is treated as a true lease (not a loan) for book accounting purposes. As defined in FASB 13, an operating lease must have all of the following characteristics: (1) Lease term is less than 75% of the estimated economic life of the equipment; (2) Present value of lease payments is less than 90% of the equipment's fair market value; (3) Lease cannot contain a bargain purchase option (i.e., less than fair market value); and (4) Ownership is retained by the lessor during and after the lease term. An operating lease is accounted for by the lessee without showing an asset (for the equipment) or a liability (for the lease payment obligations) on his/her balance sheet. Note that FASB 13 is the Financial Accounting Standards Board Statement No. 13, “Accounting for Leases” and contains specific guidelines for proper classification, accounting and reporting of lease transactions. A lease that qualifies as an operating lease for the lessee's financial accounting purposes is often referred to as Off-Balance Sheet Financing due to their exclusion from the balance sheet asset and debt presentation except for that portion of the payments that is due in the current fiscal period. Full disclosure of such transactions is typically made in the auditor's notes to the financial statements. Periodic statements are recorded as expense items on the lessee's income statement.

When you structure your lease so that you get all the benefits of using the equipment, combined with all the tax benefits, it is important to accurately calculate the fair market value of the leased equipment because capital assets depreciate over time. Depreciation decreases the company's balance sheet assets and is also recorded as an operating expense for each period. Major assets that will be used in your business for more than a year are known as “capital assets” and are subject to special treatment under the tax laws. Most importantly, you generally can't deduct the entire cost of acquiring such an asset in the year you acquire it. Because one of the goals of accounting is to accurately measure a business's gross income, expenses, and net income (earnings) during a given period of time, usually a year, if a business were allowed to reduce one year's gross income by an expense deduction for the total cost of an item that will be used for several years, the result would be an understatement of earnings in the year the asset was purchased and an overstatement of earnings during the following years. It follows that, for “capital assets” (assets that have a useful life of more than one year), the cost must be written off (that is, depreciated or amortized) over more than one year.

Theoretically, the cost of an asset should be deducted over the number of years that the asset will be used, according to the actual drop in value that the asset will suffer each year. At the end of each year, you could subtract all depreciation claimed to date from the cost of the asset, to arrive at the asset's “book value,” which would be equal to its market value. At the end of the asset's useful life for the business, any undepreciated portion would represent the salvage value for which the asset could be sold or scrapped. Since the actual drop in value of each business asset would be difficult and time-consuming to compute (if indeed it could be computed at all), accountants use a variety of conventions to approximate and standardize the depreciation process.

Various methods of depreciation are used which alter the number of periods over which the cost is allocated and the amount expensed each period. For example, the Straight Line method assumes that the asset depreciates by an equal percentage of its original value for each year that it's used. In contrast, the Declining Balance method assumes that the asset depreciates more in the earlier years. The Straight Line method results in the same deduction amount every year, while the Declining Balance method results in larger deductions in the first years and much smaller deductions in the last two years. One implication of this system is that if the equipment is expected to be sold for a higher value at some point in the middle of its life the declining balance method can result in a greater taxable gain that year because the book value of the asset will be relatively lower. A tax deduction representing a reasonable allowance for exhaustion, wear and tear, and obsolescence, that is taken by the owner of the equipment and by which the cost of the equipment is allocated over time.

Companies frequently enter into long-term lease agreements in which customers pay a single negotiated monthly fee in return for the equipment, service, supplies and financing referred to as bundled leases and the monthly payment as “Total Cost of Ownership” (“TCO”) as bundled lease transactions may constitute a majority of sales revenue. Under GAAP, most of the fair market value of a leased product can be recognized as revenue immediately if certain requirements are met, while non-equipment revenues such as service and financing are recognized over the term of the lease.

Financial Accounting Standard (“FAS”) 13, an Original Pronouncement of the Financial Accounting Standards Board (“FASB”), sets forth the rules accountants must follow under GAAP in accounting for lease revenue. Under FAS 13, monthly payments due under ordinary leases are recognized only as they become due during the term of the lease. But equipment leases meeting certain criteria are accounted for under FAS 13 as if the lessor has sold the equipment and provided financing for the sale. “Sales-type” lease accounting results in immediate revenue recognition of a large portion of the lease payments representing the equipment sale, with a smaller portion recognized gradually as interest income over the lease term. For these sales-type leases, FAS 13 requires the company to record the equipment sale at the equipment's fair value.

One method is to derive the estimated fair value of the equipment as the portion of the lease payments remaining after subtracting the estimated fair value of the service and financing components. Under this method, as deferred revenues attributed to services and financing decline, the equipment sales revenue that was recognized increases. Thus, every additional dollar allocated meant a dollar more of immediate revenue, but a dollar less that could be recognized in later years. GAAP prohibits retroactively increasing the estimated residual value of equipment thus disallowing the derivation of equipment revenue for sales-type leases from its estimate of the fair value of services and financing.

What is needed in this art is a method for determining the Fair Market Value of Leased Equipment in a multi-pricing environment by comparing the distributions of the lease transactions to the cash transactions for identical products during identical durations.

### SUMMARY OF THE INVENTION

The present invention is a method for determining the Fair Market Value of Leased Equipment in a multi-pricing environment by comparing the distributions of the lease transactions to the cash transactions for identical products during identical durations.

The invention of the present method involves first defining a population for Product Cash Revenue and a population for Product Lease Revenue and calculating the mean, median, and variance of the populations and determining therefrom the normality of each of the distributions. Next, the variances of each of the distributions are compared for equivalency by a Homogeneity of Variance test. If each of the distributions are not normal and the variances are not equal then the fair market value is not determinable. Otherwise, if each of the distributions are not normal and the variances are equal then the method further comprises determining if the medians of each of the distributions are equivalent by Mann-Whitney. If the medians of each of the distributions are not equivalent then the values of the leases are adjusted by the lowest constant in whole dollars until the means of each distribution are equivalent. However, if the medians of each of the distributions are equivalent then the cash population is equivalent to the lease population for fair market value purposes. If each of the distributions are normal then the means of each of the distributions need to be compared for equality wherein if the variances are equal then the test for determining if the means are equal is a T-Test for equal variances and if the variances are not equal then the test for determining if the means are equal is a T-Test for unequal variances. If the means are equivalent then the cash population is equivalent to the lease population for fair market value purposes but if the means are not equivalent then the values of the leases need to be adjusted by the lowest constant in whole dollars until the means of each distribution are equivalent.

Advantageously, the present method determines the proper adjustment to the lease prices in order to convert them to cash prices representing the cash value of those transactions by analyzing the variances and means/medians of each distribution. If adjustments are required, they are in constant whole dollars. Once the distribution of the lease transactions is statistically equivalent to the distribution of the cash transactions, the fair market value of the product lease has been identified and the method advantageously identifies conditions under which the results are to be considered statistically unsound.

### BRIEF DESCRIPTION OF THE DRAWINGS

The preferred embodiments and other aspects of the invention will become apparent from the following detailed description of the invention when read in conjunction with the accompanying drawings which are provided for the purpose of describing embodiments of the invention and not for limiting same, in which:

FIG. 1 is a flow diagram of the method of the present invention.

### DETAILED DESCRIPTION OF THE SPECIFICATION

The present invention is a method for determining the Fair Market Value of Leased Equipment in a multi-pricing environment by comparing the distributions of the lease transactions to the cash transactions for identical products during identical durations. The present invention provides a method for calculating the cash value of lease equipment when variations in lease and cash pricing structures due to sale range, trade-in, and customer preference discounts exist. The present method determines the proper adjustment to the lease prices in order to convert them to cash prices representing the cash value of those transactions by analyzing the variances and means/medians of each distribution. If adjustments are required, they are advantageously in constant whole dollars easily applied to each lease. Once the distribution of the lease transactions is statistically equivalent to the distribution of the cash transactions, the fair market value of the product lease has been identified. The method advantageously identifies conditions under which the results are to be considered statistically unsound.

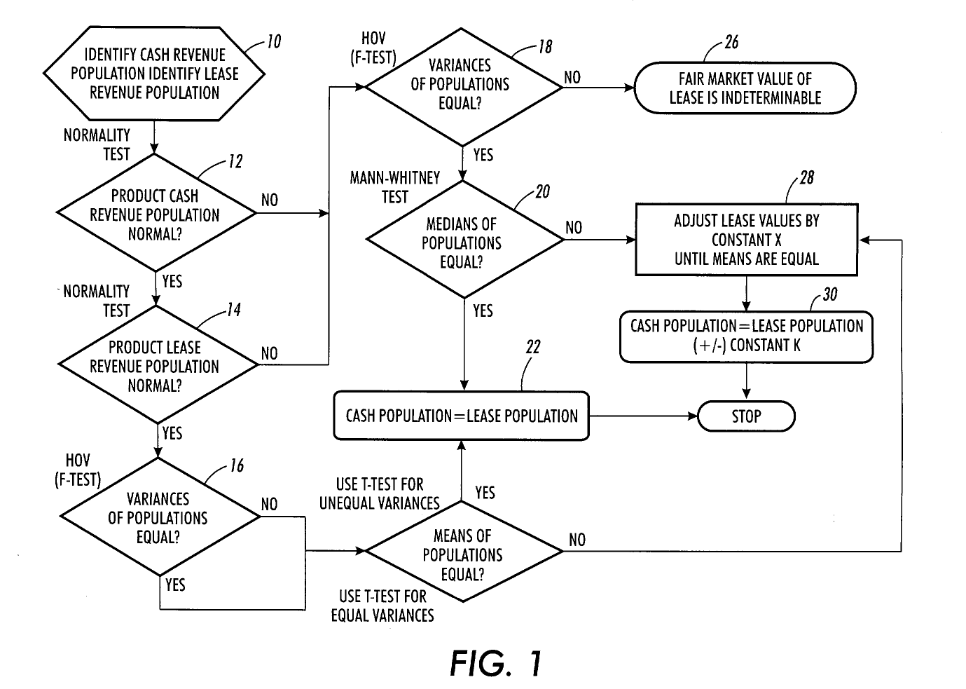

With reference now being made to the flowchart illustrated in FIG. 1, the method of for determining the Fair Market Value of Leased Equipment begins at 10 by first identifying the Cash Revenue Population (cash sales equipment) and the Lease Revenue Populations (equipment lease sales). With this data the means, median, and variances are calculated for use as herein further described.

The normality of both populations is determined wherein one hundred percent (100%) of the transactions in each category is utilized. A good test involves the Anderson-Darling test wherein p>0.05 in order to assume a normal distribution for a=0.05. If the Product Cash Revenue Population is considered normal then, at 12, a determination is made as to whether or not the Product Lease Revenue Population is normal at 14.

If, at block 12 or block 14, neither the Product Cash Revenue Population nor the Product Lease Revenue Populations are considered normal then flow proceeds to 18 wherein the same Homogeneity of Variance (HOV) test is used to determine if the variances are equal.

Are the cash and lease population variances equal?

H₀: S²cash=S² lease

H₁: S² cash=S² lease

Homogeneity of variance (F− test, F_{calculated}<F_{critical} to fail to reject null hypothesis)

F_{calculated}=S² cash/S² lease

If at 18 the distribution's variances are not equivalent then the Fair Market Value of the Lease cannot be determined 26.

If, at 12 or 14, neither the Product Cash Revenue Population nor the Product Lease Revenue Populations are considered normal then flow control proceeds to block 16 wherein a Homogeneity of Variance (HOV) F-test is used to determine if the variances are equal. If the F-test shows the distribution variances to be equivalent then a T-test for equal variances determines if the distribution means are equal at 24. If the F-test results in distribution variances which are not equivalent then a T-test for unequal variances determines if the means are equal at 24. Thus, both branches of the decision block of 16 go into the block 24 with different tests being used.

If, at 24, the means of the cash and the means of the lease distributions are equivalent under the appropriate T-test then the populations of each are considered to be statistically equivalent. Thus, the Fair Market Value of the Lease Equipment equals the cash value for that equipment at 22. Thus, the lease population is assumed to be equivalent to the variance in the cash population.

If, at 24, the means of the cash and the means of the lease distributions are not equivalent under the appropriate T-test then, at 28, the lease values are adjusted by a Constant X until the means are equal. Control then passes to 30 wherein the Cash Population equals the Lease Population plus or minus k.

The constant adjustment may be positive or negative. The constant adjustment must be in whole dollars. Constant adjustment in terms of percentage should be considered invalid. The lowest constant adjustment that makes both distributions equivalent via the appropriate T-test is to be utilized. Once the distributions of lease and cash are equivalent then the constant whole dollar value is added (or subtracted depending on the particular case) from each lease transaction and the Fair Market Value is established.

[image]

If at 18 the distribution's variances are equivalent then, at 20, the Mann-Whitney Test (or other non-parametric medians tests) determines whether the medians of the distributions are equal.

If, at 20, the medians of the cash and the lease distributions are equivalent under the Mann-Whitney test then the Fair Market Value of the Lease Equipment equals the cash value for that equipment at 22. Thus, the lease population is assumed to be equivalent to the variance in the cash population.

If, at 20 the medians of the cash and the lease distributions are not equivalent under the Mann-Whitney test then, at 28, the lease values are adjusted by a Constant X until the means are equal. Control then passes to 30 wherein the Cash Population equals the Lease Population plus or minus k. Again, the constant adjustment may be positive or negative. The constant adjustment must be in whole dollars. Constant adjustment in terms of percentage should be considered invalid. The lowest constant adjustment that makes both distributions equivalent via the appropriate T-test is to be utilized. Once the distributions of lease and cash are equivalent then the constant whole dollar value is added (or subtracted depending on the particular case) from each lease transaction and the Fair Market Value is established.

In summary, the present method first defines a population for Product Cash Revenue and a population for Product Lease Revenue and calculating the mean, median, and variance of the populations and determining therefrom the normality of each of the distributions. Next, the variances of each of the distributions are compared for equivalency by a Homogeneity of Variance test. If each of the distributions are not normal and the variances are not equal then the fair market value is not determinable. Otherwise, if each of the distributions are not normal and the variances are equal then the method further comprises determining if the medians of each of the distributions are equivalent by Mann-Whitney. If the medians of each of the distributions are not equivalent then the values of the leases are adjusted by the lowest constant in whole dollars until the means of each distribution are equivalent. However, if the medians of each of the distributions are equivalent then the cash population is equivalent to the lease population for fair market value purposes. If each of the distributions are normal then the means of each of the distributions need to be compared for equality wherein if the variances are equal then the test for determining if the means are equal is a T-Test for equal variances and if the variances are not equal then the test for determining if the means are equal is a T-Test for unequal variances. If the means are equivalent then the cash population is equivalent to the lease population for fair market value purposes but if the means are not equivalent then the values of the leases need to be adjusted by the lowest constant in whole dollars until the means of each distribution are equivalent.

Advantageously, the present method determines the proper adjustment to the lease prices in order to convert them to cash prices representing the cash value of those transactions by analyzing the variances and means/medians of each distribution. If adjustments are required, they are in constant whole dollars. Once the distribution of the lease transactions is statistically equivalent to the distribution of the cash transactions, the fair market value of the product lease has been identified and the method advantageously identifies conditions under which the results are to be considered statistically unsound.

What is claimed is:

1. A method for determining Fair Market Value of leased equipment in a multi-pricing environment for identical products during identical durations when variations in lease and cash pricing structures exist, comprising:
a) defining a population for Product Cash Revenue and a population for Product Lease Revenue;
b) calculating the mean, median, and variance of the populations and determining therefrom the normality of each of the distributions; and
c) determining if the variances of each of the distributions are equivalent;

2. A method as in claim 1, if each of the distributions are not normal and the variances are equal then further comprising determining if the medians of each of the distributions are equivalent.

3. A method as in claim 1, if each of the distributions are not normal and the variances are not equal then the fair market value is not determinable.

4. A method as in claim 2, if the medians of each of the distributions are not equivalent then further comprising adjusting the values of the leases by the lowest constant in whole dollars until the means of each distribution are equivalent.

5. A method as in claim 2, if the medians of each of the distributions are equivalent then further comprising equating the cash population with the lease population.

6. A method as in claim 1, if each of the distributions are normal then further comprising determining if the means of the distributions are equal.

7. A method as in claim 6, if the variances are equal then the test for determining if the means are equal is a T-Test for equal variances and if the variances are not equal then the test for determining if the means are equal is a T-Test for unequal variances.

8. A method as in claim 6, if the means are equivalent then further comprising equating the cash population with the lease population and if the means are not equivalent then further comprising adjusting the values of the leases by the lowest constant in whole dollars until the means of each distribution are equivalent.

9. A method as in claim 1 wherein determining the equality of the variances is done by a Homogeneity of Variance (HOV) F-test.

10. A method as in claim 2 wherein determining the equality of the medians is done by a non-parametric medians tests such as Mann-Whitney.

11. A method for determining Fair Market Value of leased equipment in a multi-pricing environment for identical products during identical durations when variations in lease and cash pricing structures exist, comprising:
a) defining a population for Product Cash Revenue and a population for Product Lease Revenue;
b) calculating the mean, median, and variance of the populations and determining therefrom the normality of each of the distributions;
c) determining if the variances of each of the distributions are equivalent;
d) if each of the distributions are not normal and the variances are not equal then the fair market value is not determinable;
e) if each of the distributions are not normal and the variances are equal then further comprising determining if the medians of each of the distributions are equivalent;
f) if the medians of each of the distributions are not equivalent then further comprising adjusting the values of the leases by the lowest constant in whole dollars until the means of each distribution are equivalent; and
g) if the medians of each of the distributions are equivalent then further comprising equating the cash population with the lease population.

12. A method as in claim 11, if each of the distributions are normal then further comprising determining if the means of the distributions are equal.

13. A method as in claim 12, if the variances are equal then the test for determining if the means are equal is a T-Test for equal variances and if the variances are not equal then the test for determining if the means are equal is a T-Test for unequal variances.

14. A method as in claim 12, if the means are equivalent then further comprising equating the cash population with the lease population and if the means are not equivalent then further comprising adjusting the values of the leases by the lowest constant in whole dollars until the means of each distribution are equivalent.

15. A method as in claim 11 wherein determining the equality of the variances is done by a Homogeneity of Variance (HOV) F-test.

16. A method as in claim 12 wherein determining the equality of the medians is done by a non-parametric medians tests such as Mann-Whitney.

17. A method for determining Fair Market Value of leased equipment in a multi-pricing environment for identical products during identical durations when variations in lease and cash pricing structures exist, comprising:
a) defining a population for Product Cash Revenue and a population for Product Lease Revenue and calculating the mean, median, and variance of the populations and determining therefrom the normality of each of the distributions;
b) determining if the variances of each of the distributions are equivalent;
c) if each of the distributions are not normal and the variances are not equal then the fair market value is not determinable;
d) if each of the distributions are not normal and the variances are equal then further comprising determining if the medians of each of the distributions are equivalent;
e) if the medians of each of the distributions are not equivalent then further comprising adjusting the values of the leases by the lowest constant in whole dollars until the means of each distribution are equivalent;
f) if the medians of each of the distributions are equivalent then further comprising equating the cash population with the lease population; and
g) if each of the distributions are normal then further comprising determining if the means of the distributions are equal;
h) if the variances are equal then the test for determining if the means are equal is a T-Test for equal variances and if the variances are not equal then the test for determining if the means are equal is a T-Test for unequal variances; and
i) if the means are equivalent then further comprising equating the cash population with the lease population and if the means are not equivalent then further comprising adjusting the values of the leases by the lowest constant in whole dollars until the means of each distribution are equivalent.

18. A method as in claim 17 wherein determining the equality of the variances is done by a Homogeneity of Variance (HOV) F-test.

19. A method as in claim 17 wherein determining the equality of the medians is done by a non-parametric medians tests such as Mann-Whitney.

20. A method for determining Fair Market Value of leased equipment in a multi-pricing environment for identical products during identical durations when variations in lease and cash pricing structures exist, comprising:
a) defining a population for Product Cash Revenue and a population for Product Lease Revenue and calculating the mean, median, and variance of the populations and determining therefrom the normality of each of the distributions;
b) determining if the variances of each of the distributions are equivalent by a Homogeneity of Variance test;
c) if each of the distributions are not normal and the variances are equal then further comprising determining if the medians of each of the distributions are equivalent by a Mann-Whitney test;
d) if the medians of each of the distributions are not equivalent then further comprising adjusting the values of the leases by the lowest constant in whole dollars until the means of each distribution are equivalent;
e) if the medians of each of the distributions are equivalent then further comprising equating the cash population with the lease population; and
f) if each of the distributions are normal then further comprising determining if the means of the distributions are equal;
g) if the variances are equal then the test for determining if the means are equal is a T-Test for equal variances and if the variances are not equal then the test for determining if the means are equal is a T-Test for unequal variances; and
h) if the means are equivalent then further comprising equating the cash population with the lease population and if the means are not equivalent then further comprising adjusting the values of the leases by the lowest constant in whole dollars until the means of each distribution are equivalent.
